(19) United States
(12) Patent Application Publication
(10) Pub. No.: US 2026/0094123 A1
(43) Pub. Date: Apr. 2, 2026

(54) Computing System and Method for Generating Correspondence Using Artificial Intelligence

(71) Applicant: Procore Technologies, Inc., Carpinteria, CA (US)

(72) Inventors: Siddhartha Chatterjee, Austin, TX (US); Kartik Suresh, Brampton (CA); Thomas Noctor, Dublin (IE)

(21) Appl. No.: 18/902,259

(22) Filed: Sep. 30, 2024

(51) Int. Cl. G06Q 10/10; G06Q 50/08

(52) U.S. Cl. CPC G06Q 10/103; G06Q 50/08

(57) ABSTRACT

Disclosed herein is a computing platform configured to: (i) receive a request to generate a given project-related correspondence entry for a given user associated with a given party involved in a construction project; (ii) after receiving the request, make a determination of whether to generate a draft of the given project-related correspondence entry using either (a) an industry-level artificial intelligence (AI) model, or (b) a party-level AI model for the given party; and (iii) based on the determination, either (a execute the industry-level AI model to generate the draft of the given project-related correspondence entry in accordance with terminology used within a construction industry or (b) execute the party-level AI model to generate the draft of the given project-related correspondence entry in accordance with terminology that is specific to the given party.

### BACKGROUND

Construction projects are often complex endeavors involving the coordination of many professionals across several discrete phases. Because of this, parties involved in construction projects have increasingly begun to use software applications to manage those construction projects. One example of such a software application is the software-as-a-service (SaaS) application for construction management offered by Procore Technologies, Inc. (“Procore”), who is the current applicant. Using construction management software applications such as these, parties can create a digital representation of a given construction project that is to be managed and then create, store, view, and/or interact with various types of digital project data associated with the given construction project. Such digital project data may take various forms, examples of which may include schedules, daily logs, images, drawings, specifications, correspondence, building information models (BIMs), sensor data, budgets, change orders, communications, invoices, directories, punch lists (e.g., which list work that has not yet been completed or has been completed incorrectly), timesheets, requests for information (RFIs), submittals, and/or reports, among other types of information, among many other examples of digital data that may be stored for a construction project.

### SUMMARY

Disclosed herein is a new software technology for generating correspondence related to a construction project using Artificial Intelligence (AI).

In one aspect, the disclosed technology may take the form of a method that involves (i) receiving a request to generate a given project-related correspondence entry for a given user associated with a given party involved in a construction project, (ii) after receiving the request, making a determination of whether to generate a draft of the given project-related correspondence entry using either (a) an industry-level AI model, or (b) a party-level AI model for the given party, and (iii) based on the determination, either (a) executing the industry-level AI model to generate the draft of the given project-related correspondence entry in accordance with terminology used within a construction industry or (b) executing the party-level AI model to generate the draft of the given project-related correspondence entry in accordance with terminology that is specific to the given party.

In some implementations where a determination is made to use the industry-level AI model to generate the draft of the given project-related correspondence entry, the method may further involve (i) causing the draft of the given project-related correspondence entry generated by the industry-level AI model to be presented to the given user, (ii) receiving data defining interactions of the given user with the draft of the given project-related correspondence entry generated by the industry-level AI model, and based on the received data, refining the industry-level AI model, and/or (iii) before executing the industry-level AI model, transforming the received request into a prompt for the industry-level AI model that comprises an instruction to generate the draft of the given project-related correspondence entry, and providing the generated prompt as input to the industry-level AI model.

In some implementations where a determination is made to use the party-level AI model to generate the draft of the given project-related correspondence entry, the method may further involve (i) after executing the party-level AI model to generate the draft of the given project-related correspondence entry, making a second determination of whether to (a) update the draft of the given project-related correspondence entry generated by the party-level AI model using a user-level AI model for the given user or (b) causing the draft of the given project-related correspondence entry generated by the party-level AI model to be presented to the given user, and based on the second determination, either (a) executing the user-level AI model to generate an updated draft of the given project-related correspondence entry in accordance with terminology that is specific to the given user, or (b) causing the draft of the given project-related correspondence entry generated by the party-level AI model to be presented to the given user.

In some implementations where the second determination is to cause the draft of the given project-related correspondence entry generated by the party-level AI model to be presented to the given user, the method may further involve receiving data defining interactions of the given user with the draft of the given project-related correspondence entry generated by the party-level AI model, and based on the received data, refining the party-level AI model.

In other implementations where the second determination is to update the draft of the given project-related correspondence entry generated by the party-level AI model using the user-level AI model, the method may further involve, before executing the user-level AI model, generating a prompt for the user-level AI model that comprises an instruction to generate the updated draft of the given project-related correspondence entry, and providing the generated prompt as input to the user-level AI model.

Further, in some implementations, the method may further involve, before executing the party-level AI model, transforming the received request into a prompt for the party-level AI model that comprises an instruction to generate the draft of the given project-related correspondence entry, and providing the generated prompt as input to the party-level AI model.

Further yet, in some implementations, the method may further involve (i) creating the industry-level AI model by fine tuning a pre-trained generative AI model using prior project-related correspondence entries drafted by individuals involved in the construction industry, (ii) creating the party-level AI model by fine tuning a previously-trained generative AI model (e.g., the industry-level AI model or a pre-trained generative AI model which may not have been further trained with industry-level dataset) using prior project-related correspondence entries drafted by individuals associated with the given party, and/or (iii) creating the user-level AI model by further training a previously-trained generative AI model (e.g., the industry-level AI model, the party-level AI model, or a pre-trained generative AI model which may not have been further trained with industry-level dataset or party-level dataset) via few-shot learning using prior project-related correspondence entries drafted by the given user.

In another aspect, the disclosed technology may take the form of a computing platform comprising at least one processor, at least one non-transitory computer-readable medium, and program instructions stored on the at least one non-transitory computer-readable medium that are executable by the at least one processor such that the computing platform is configured to carry out the functions of the aforementioned method.

In yet another aspect, the disclosed technology may take the form of a non-transitory computer-readable medium comprising program instructions stored thereon that are executable by at least one processor to cause a computing platform to carry out the functions of the aforementioned method.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIG. 1 depicts an example network configuration in which example embodiments may be implemented.

FIG. 2A depicts an example user-interface view of a Correspondence Tool of a construction management software application.

FIG. 2B depicts another example user-interface view of a Correspondence Tool of a construction management software application.

FIG. 2C depicts yet another example user-interface view of a Correspondence Tool of a construction management software application.

FIG. 3 depicts an example software-based pipeline for generating project-related correspondence.

FIG. 4A depicts example content that may be included in a user request.

FIG. 4B depicts an example project-related correspondence entry generated by an industry-level AI model.

FIG. 4C depicts an example project-related correspondence entry generated by a party-level AI model.

FIG. 4D depicts an example project-related correspondence entry generated by a user-level AI model.

FIG. 5A depicts an example flow chart for creating an industry-level AI model.

FIG. 5B depicts an example flow chart for creating a party-level AI model.

FIG. 5C depicts an example flow chart for creating a user-level AI model.

FIG. 6 depicts a flow diagram of an example process that may be carried out in accordance with the disclosed software-based pipeline for generating project-related correspondence.

FIG. 7 depicts an example computing platform that may be configured to carry out one or more of the functions of the present disclosure.

FIG. 8 depicts an example client device that may be configured to carry out one or more of the functions of the present disclosure.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure refers to the accompanying figures and several examples. One of ordinary skill in the art would understand that such references are for the purpose of explanation only and are therefore not meant to be limiting. Part or all of the disclosed systems, devices, and methods may be rearranged, combined, added to, and/or removed in a variety of manners, each of which is contemplated herein.

As noted above, construction management today is often performed through the use of software applications, such as the software application for construction management provided by Procore Technologies, Inc.®, the applicant of the present disclosure. These software applications generally provide users with the ability to create, store, view, and/or interact with various types of digital data related to a construction project, such as schedules, daily logs, images, drawings, specifications, correspondence, building information models (BIMs), sensor data, budgets, change orders, communications, invoices, directories, punch lists (e.g., which list work that has not yet been completed or has been completed incorrectly), timesheets, requests for information (RFIs), submittals, and/or reports, among many other examples of digital data that may be stored for a construction project. In practice, these construction management software applications may take various forms.

As one possible implementation, a construction management software application may include both front-end software (e.g., a web application, desktop application, or mobile application) running on client devices that are accessible to individuals associated with construction projects (e.g., contractors, project managers, architects, engineers, designers, etc.) and back-end software running on a back-end computing platform (sometimes referred to as a “cloud” platform) that interacts with and/or drives the front-end software, and which may be operated (either directly or indirectly) by the provider of the front-end software. This form of a software application may be referred to as a client-server application or a software-as-a-service (Saas) application, among other possibilities. As another possible implementation, a construction management software application may include front-end software that runs on client devices without interaction with a back-end computing platform. These construction management software applications may take other forms as well.

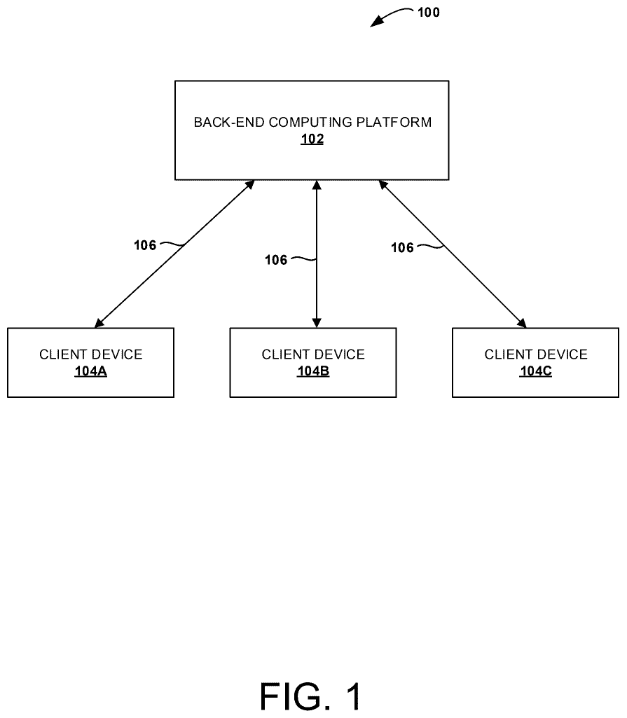

Turning now to the figures, FIG. 1 depicts an example network environment 100 in which a construction management software application may be implemented. As shown in FIG. 1, the network environment 100 includes a back-end computing platform 102 that may be communicatively coupled to one or more client devices 104, which as shown includes the client device 104A, the client device 104B, and the client device 104C. Although the client devices 104 are depicted by three devices as shown for the sake of simplicity in illustration, it should be understood that the client devices 104 may represent more or less than three devices without departing from the spirit and scope of this disclosure.

Broadly speaking, the back-end computing platform 102 may comprise one or more computing systems that have been provisioned with back-end software for a construction management software application, which may include program code for carrying out one or more of the platform-side functions disclosed herein. The one or more computing systems of back-end computing platform 102 may collectively comprise some set of physical computing resources (e.g., one or more processors, data storage system, communication interfaces, etc.), which may take various forms and be arranged in various manners.

For instance, as one possibility, the back-end computing platform 102 may comprise computing infrastructure of a public, private, and/or hybrid cloud (e.g., computing and/or storage clusters) that has been provisioned with back-end software for the construction management software application. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with back-end software for the construction management software application.

Further, in practice, the back-end software installed at the back-end computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the back-end software installed at the back-end computing platform 102 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 102 may comprise various other components and take various other forms as well.

In turn, the client devices 104 may each be any computing device that is capable of running front-end software of the construction management software application, which may include program code for carrying out the client-side functions disclosed herein. In this respect, the client devices 104 may each include hardware components such as one or more processors, computer-readable mediums, communication interfaces, and input/output (I/O) components (or interfaces for connecting thereto), among others, as well as software components that facilitate the client device's ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 1, the back-end computing platform 102 is configured to interact with the client devices 104 over respective communication paths 106. In this respect, each communication path 106 between the back-end computing platform 102 and one of the client devices 104 may generally comprise one or more communication networks and/or communications links, which may take any of various forms. For instance, each respective communication path 106 with the back-end computing platform 102 may include any one or more of Personal Area Networks (PANs), Local-Area Networks (LANs), Wide-Area Networks (WANs) such as the Internet or cellular networks, cloud networks, and/or point-to-point links, among other possibilities. Further, the communication networks and/or links that make up each respective communication path 106 with the back-end computing platform 102 may be wireless, wired, or some combination thereof, and may carry data according to any of various different communication protocols. Further yet, communications over each respective communication path 106 could be carried out via an Application Programming Interface (API), among other possibilities. Still further, although not shown, the respective communication paths 106 between the client devices 104 and the back-end computing platform 102 may also include one or more intermediate systems. For example, it is possible that the back-end computing platform 102 may communicate with a given client device 104 via one or more intermediary systems, such as a host server (not shown). Many other environments are also possible.

Although not shown in FIG. 1, the back-end computing platform 102 may also be configured to receive data, such as data related to a construction project, from one or more external data sources, such as an external database and/or another back-end computing platform or platforms. Such data sources—and the data output by such data sources—may take various forms.

It should be understood that the network environment 100 depicted in FIG. 1 is one example of a network environment in a construction management software application may be implemented. Numerous other arrangements are possible and contemplated herein. For instance, other network configurations may include additional components not pictured and/or more or fewer of the pictured components.

In operation, existing construction management software applications may enable a representative of a given party that wishes to utilize a construction management software application to (i) create an account with the construction management software application and (ii) add a set of individuals associated with the given party as users on the given party's account. After the given party's account is created and a set of users have been added, the construction management software application may thereafter enable the representative of the given party (or some other representative that has been added to the account as a user having the requisite permissions) to (i) create a respective project workspace for each of one or more construction projects that involve the given party and (ii) for each such construction project, designate a respective subset of the given party's users that are allowed to access data associated with the respective project workspace. In this respect, the given party may be considered to be the “owner” of the project workspace(s) and the data contained therein.

Along with adding the set of users to the given party's account and designating the respective subsets of users for the project workspaces, the construction management software application may further enable the representative of the given party (or some other representative that has been added to the account as a user having the requisite permissions) to define different permissions for such users, which may either be specific to each respective project workspace to which the users have been added (i.e., project-level permissions) or may be global to all project workspaces (i.e., account-level permissions). In practice, such permissions may be defined in terms of the types of data objects that can be accessed, the types of software features that can be utilized by the user, and/or the extent of access granted with respect to data object and/or software features (e.g., read/write access, read-only access, etc.), among other possibilities.

As noted above, existing construction management software applications may enable users to electronically manage construction projects, which may involve software features for creating, storing, viewing, and/or interacting with any of various types of digital data objects, including but not limited to any of the various types of digital data objects discussed above. Further, in at least some implementations, the software features for creating, storing, viewing, and/or interacting with the various types of data objects may be arranged into different software “tools” that each correspond to a different type of data object.

One such tool that may be included in a construction management software application is a “Correspondence” tool that enables a party involved in construction projects to manage electronic correspondence related to those construction projects, which may be referred to herein as “project-related correspondence.” In practice, such a Correspondence tool may enable management of any of various types of project-related correspondence, examples of which may include correspondence regarding notices (e.g., notice to proceed, notice of delay, etc.), approvals, requests (e.g., an RFI, request for proposal (RFP), request for quote (RFQ), change request, project progress request, extensions of time request, warranty request, etc.), or status updates, among other types of correspondence concerning a construction project. Further, such a Correspondence tool may enable a party to engage in any of various management activities with respect to project-related correspondence, examples of which may include creating, sending, receiving, viewing, responding to, and/or tracking project-related correspondence.

For instance, according to one aspect, the Correspondence tool may present a given user of a party with an interface for creating a new project-related correspondence entry for a construction project that includes a set of data fields for inputting header-type information for the project-related correspondence entry (e.g., a “To:” field, a “Subject” field, a “Status” field, a “Due Date” field, etc.) along with a data field for inputting the body of the project-related correspondence entry (e.g., a “Description” field). Additionally, in some implementations, the Correspondence tool may have the capability to present customized interfaces for creating certain types of project-related correspondence, where each such customized interface may include a customized set of data fields for inputting header-type information for a project-related correspondence entry of a given type along with the data field for inputting the body of the correspondence entry.

According to another aspect, the Correspondence tool may present a given user of a party with an interface that enables the party to view a listing of project-related correspondence that has been created for a construction project and take certain actions with respect to the project-related correspondence, such as selecting a given project-related correspondence entry to review in further detail. In this respect, the listing of project-related correspondence may be organized in any of various manners, including but not limited to the possibility that project-related correspondence could be grouped and/or sorted based on the type of correspondence.

According to yet another aspect, after a given user of a party selects a given project-related correspondence entry to review in further detail, the Correspondence tool may present the given user with an interface that (i) shows the contents of the given project-related correspondence entry, (ii) enables the given user to take certain actions with respect to the project-related correspondence entry, such as editing the given project-related correspondence entry, changing the status of the given project-related correspondence entry, and/or posting a response to the given project-related correspondence entry, and perhaps also (iii) show prior activity with respect to the given project-related correspondence entry, such as any previous edits made to the given project-related correspondence entry (i.e., the “change history” for the given project-related correspondence) and/or any previously-posted responses for the given project-related correspondence entry.

A Correspondence tool of a construction management software application may enable a given user of a party to engage in other types of management activities with respect to project-related correspondence as well.

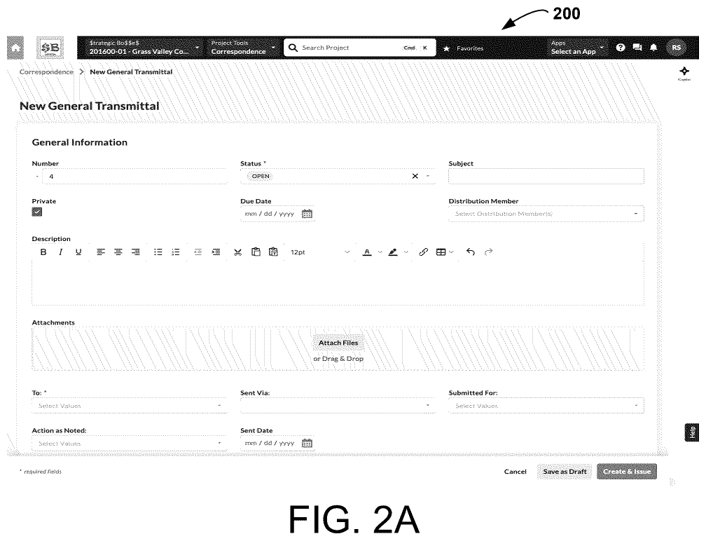

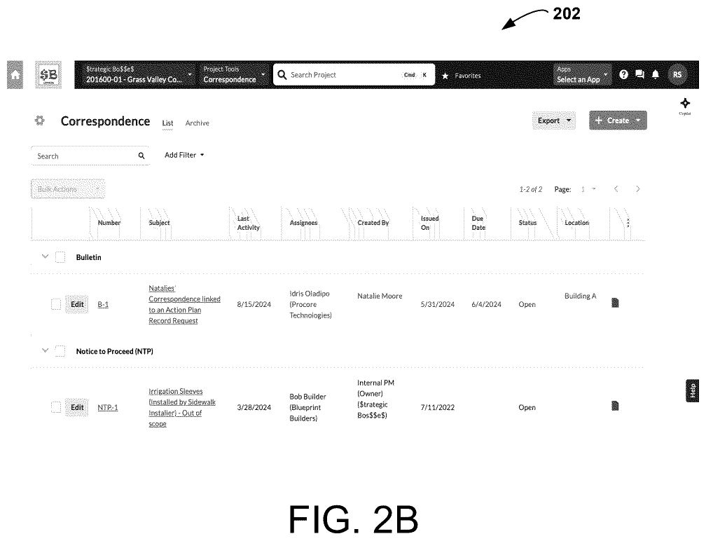

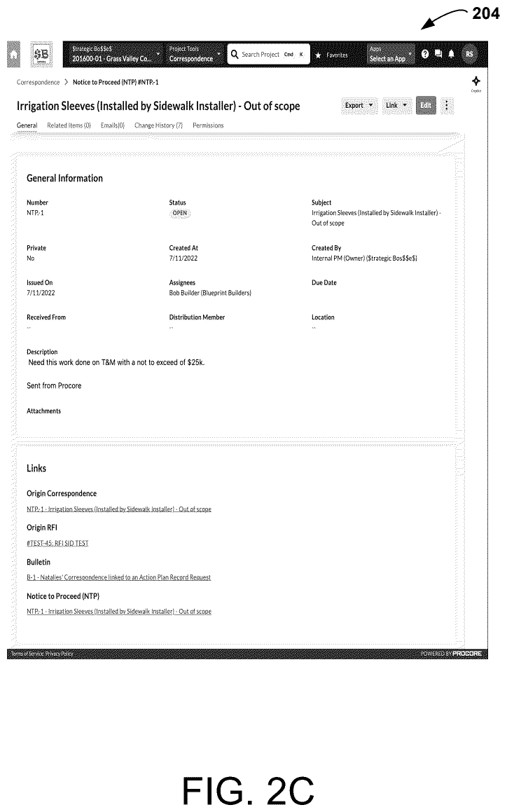

One possible example of a Correspondence Tool of a construction management software application is illustrated in FIGS. 2A-2C. FIG. 2A depicts an example user-interface view 200 for creating a new project-related correspondence entry for a given construction project. Specifically, example user-interface view 200 may enable a given user associated with a given party to create a general project-related correspondence entry to communicate something general concerning a construction project, such as a status update. As shown, example user-interface view 200 may include a set of data fields for inputting header-type information for the new project-related correspondence entry (e.g., a “To:” field, a “Subject” field, a “Status” field, a “Due Date” field, etc.), and a data field for inputting the body of the new project-related correspondence entry (e.g., a “Description” field), among other data fields.

It should be understood that the example user-interface view 200 for creating a given type of project-related correspondence entry may take various other forms, which may depend on the type of project-related correspondence being created.

Turning to FIG. 2B, an example user-interface view 202 is shown that enables the given user associated with the given party to view a listing of project-related correspondence (e.g., “Bulletin” or “Notice to Proceed (NTP)” project-related correspondence) that has been created for a construction project. The given user may take certain actions with respect to any one of the project-related correspondence entries, such as selecting a given project-related correspondence entry (e.g., the “Notice to Proceed (NTP)” project-related correspondence entry) to review it in further detail.

It should be understood that the example user-interface view 202 may take various other forms, which may depend on the number of existing project-related correspondence and the types of existing project-related correspondence, among other aspects.

After the given user selects the given project-related correspondence entry (e.g., the “Notice to Proceed (NTP)” project-related correspondence entry) to review it in further detail, the Correspondence tool may present the given user with the example user-interface view 204 shown in FIG. 2C. As shown, example user-interface view 204 may include the contents of the given project-related correspondence entry and may enable the given user to take certain actions with respect to the given project-related correspondence entry, such as editing the given project-related correspondence entry. Although not shown in FIG. 2C, example user-interface view 204 may include additional elements to enable the given user to take various other actions as well, such as changing the status of the given project-related correspondence entry, and/or posting a response to the given project-related correspondence entry. Further, although not shown in FIG. 2C, example user-interface view 204 may also show prior activity with respect to the given project-related correspondence entry, such as any previous edits made to the given project-related correspondence entry (i.e., the “change history” for the given project-related correspondence) and/or any previously-posted responses for the given project-related correspondence entry.

In this way, a Correspondence tool of a construction management software application provides several advantages, including presenting parties involved in a construction project with a centralized hub for creating, sending, receiving, viewing, responding to, and tracking projected-related correspondence for the construction project, which enables the parties to collaborate on the construction project in a clear, transparent, and efficient way. However, construction projects often involve coordination between many different individuals and parties across several different phases (e.g., planning/design, pre-construction, procurement, construction, post-construction, etc.), and over the course of a construction project, it is possible that a very large volume of project-related correspondence entries may be created (e.g., thousands of project-related correspondence entries)—each of which may require one or more responses by one or more of the parties involved in the construction project. This can lead to several downstream problems.

First, in order to utilize a Correspondence tool of a construction management software application effectively, parties involved in a construction project may be forced to expend a significant amount of time drafting project-related correspondence entries and responses thereto, which is not desirable because it may pull the party away from engaging in other, more important tasks.

Second, as the volume of the project-related correspondence entries for a construction project increases, it becomes increasingly difficult for a party to provide timely responses to the project-related correspondence entries, which may lead to costly delays and/or other coordination problems on the construction project.

Third, the pressure to create and/or respond to project-related correspondence entries in a timely fashion may lead to the creation of inadequate project-related correspondence entries and/or responses thereto that may be inaccurate, incomplete, and/or inconsistent with a prior project-related correspondence entry. Such inadequate project-related correspondence entries and/or responses thereto may cause confusion and communication errors, which in turn may lead to costly project delays.

Unfortunately, existing construction management software applications do not include any technology that assists parties with the task of drafting project-related correspondence and/or responses thereto. For instance, while the existing construction management software application offered by Procore includes a Correspondence tool that allows parties to manage project-related correspondence for a construction project in the ways discussed above, Procore's Correspondence tool does not currently include any technology that assists parties with the task of drafting project-related correspondence and/or responses thereto.

To address these and other problems associated with existing construction management software applications, disclosed herein is new software technology for generating correspondence related to a construction project using Artificial Intelligence (AI), which may be embodied in the form of a new software-based pipeline that utilizes AI to generate projected-related correspondence for a construction project.

In practice, the disclosed software-based pipeline may be integrated into a construction management software application or provided as a standalone software tool, among other possibilities. For instance, as one possible implementation, the disclosed software-based pipeline may be integrated into a construction management software application comprising both front-end software running on client devices (e.g., client devices 104A-C of FIG. 1) that are accessible to individuals associated with construction projects (e.g., contractors, project managers, architects, engineers, designers, etc.) and back-end software running on a back-end computing platform (e.g., back-end computing platform 102 of FIG. 1) that interacts with and/or drives the front-end software. As another possible implementation, the disclosed software-based pipeline may be integrated into a construction management software application comprising front-end client software that runs on client devices without interaction with a back-end computing platform. The disclosed software technology may take other forms as well.

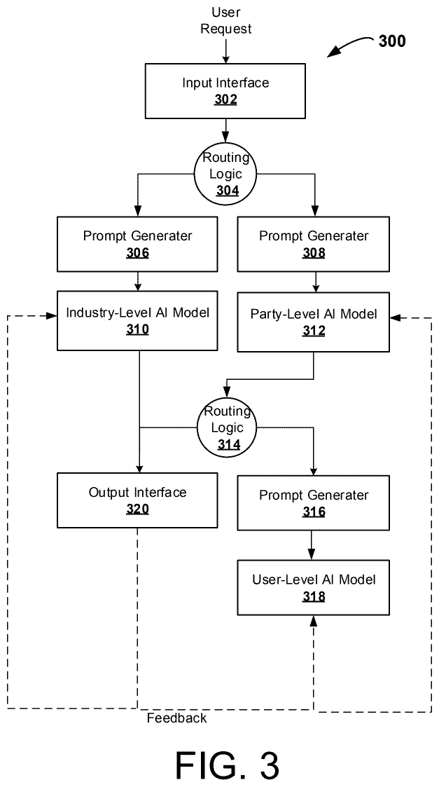

Turning now to FIG. 3, an example software-based pipeline 300 is illustrated. In practice, the example software-based pipeline 300 may be encoded in the form of program instructions that are executable by one or more processors of a computing platform, and for purposes of illustration, the example software-based pipeline 300 is described as being installed on and executed by the back-end computing platform 102 of FIG. 1, but it should be understood that the example software-based pipeline 300 may be installed on and executed by any one or more computing platforms that are capable of performing the example operations of the example software-based pipeline 300. Further, it should be understood that the example software-based pipeline 300 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular embodiment.

As shown, the example software-based pipeline 300 comprises three different types of AI models that may be utilized to generate a given project-related correspondence entry, which are referred to herein as (i) an “industry-level” AI model, (ii) a “party-level” AI model, and (iii) a “user-level” AI model. Each of these disclosed AI models may take various forms.

At a high level, an industry-level AI model may comprise an AI model that is configured to (i) receive a prompt comprising an instruction to generate a given project-related correspondence entry for a user associated with a party and (ii) generate a draft of the given project-related correspondence entry in accordance with terminology that is specific to the construction industry (e.g., terms and/or linguistic styles that are commonly used by professionals in the construction industry, such as RFI, RFQ, RFP, etc.).

Further, at a high level, a party-level AI model may comprise an AI model that is configured to (i) receive a prompt comprising an instruction to generate a given project-related correspondence entry for a user associated with a party and (ii) generate a draft of the given project-related correspondence entry in accordance with terminology that is specific to the party (e.g., terms and/or linguistic styles that are commonly used by the party's users in project-related correspondence).

Further yet, at a high level, a user-level AI model may comprise an AI model that is configured to (i) receive a prompt comprising an instruction to update a draft of a given correspondence entry that was previously generated by another AI model (e.g., an industry-level AI model or a party-level AI model) for a user associated with a party and (ii) generate an updated draft of the given project-related correspondence entry in accordance with terminology that is specific to the user (e.g., terms and/or linguistic styles that are commonly used by the user in in project-related correspondence).

Each of the disclosed AI models may comprise any of various types of AI models that are capable of generating correspondence, including but not limited to any of various types of generative AI models (e.g., transformer-based models, such as small language, large language and/or large multimodal models, diffusion models, generational adversarial networks, variational autoencoders, etc.). In this respect, such a generative AI model may comprise a pre-trained generative AI model (e.g., an “off-the-shelf” generative AI model, such as a GPT type of generative AI model, a BERT type of generative AI model, a BART type of generative AI model, a T5 type of generative AI model, a PEGASUS type of generative AI model, a Llama type of generative AI model, or Phi-2 or Phi-3 type of generative AI model, among other examples) that is then further trained (e.g., via fine tuning, few-shot learning, or the like) to generate and/or update correspondence in accordance with a particular type of terminology (e.g., terminology that is specific to the construction industry as a whole, a particular party involved in construction projects, or a particular user of party involved in construction projects), or may comprise a generative AI model that is trained in the first instance to generate and/or update correspondence in accordance with a particular type of terminology, among other possibilities.

As one possible implementation, an industry-level AI model may comprise a pre-trained generative AI model that is further trained via fine tuning to generate correspondence in accordance with terminology that is specific to the construction industry (but not any particular party), a party-level AI model may comprise a previously-trained generative AI model (e.g., an industry-level AI model or a pre-trained generative AI model which may not have been further trained with “industry-level dataset” discussed in further detail below) that is further trained via fine tuning to generate correspondence in accordance with terminology that is specific to a particular party that utilized the construction management software application, and a user-level AI model may comprise a previously-trained generative AI model (e.g., an industry-level AI model, a party-level AI model, or a pre-trained generative AI model which may not have been further trained with industry-level dataset or “party-level dataset” discussed in further detail below) that is further trained via few shot learning to update correspondence in accordance with terminology that is specific to a particular user of the particular party. However, other implementations are possible as well. For example, it is possible that one or more of the industry-level AI model, the party-level AI model, and/or the user-level AI model may comprise a generative AI model that is trained in the first instance to generate and/or update correspondence in accordance with a particular type of terminology. As another example, it is possible that the industry-level AI model and/or the party-level AI model could be further trained via few-shot learning rather than fine tuning, and/or that the user-level AI model could be further trained via fine tuning rather than few-shot learning. The disclosed AI models in the example software-based pipeline 300 may take other forms as well.

As shown in FIG. 3, the software-based example software-based pipeline 300 may also comprise other functional components that work together with the AI models to generate project-related correspondence entries in accordance with the present disclosure.

For instance, as shown in FIG. 3, the example software-based pipeline 300 may begin with an input interface 302 that is configured to receive a request to generate a given project-related correspondence entry for a given user that is associated with a given party. The contents of the received request to generate the given project-related correspondence entry may take various forms.

As one possibility, the contents of the received request to generate the given project-related correspondence entry may include an indication of whether the given project-related correspondence entry that is to be generated is a new project-related correspondence entry or a response to an existing project-related correspondence entry.

As another possibility, the contents of the received request to generate the given project-related correspondence entry may include additional details regarding the given project-related correspondence entry that is to be generated. Such additional details may include information that is to be included in the given project-related correspondence entry and/or information that may be used to assist in generating the given project-related correspondence entry, among other possibilities. In this respect, the additional details included in the contents of the received request may take various forms.

As one example, the additional details included in the contents of the received request may include an indication of a given type of project-related correspondence entry to create, such as a given type of notice (e.g., notice to proceed, notice of delay, etc.), a given type of request (e.g., RFI, RFP, RFQ, extension of time, change request, warranty request, etc.), a given type of report (e.g., progress report), or any other type of project-related correspondence entry that may be generated for a construction project as discussed above.

As another example, the additional details may include details about the sender of the given project-related correspondence entry (which could be the given user or another user associated with the given party), the recipient(s), the assignee(s) (e.g., individual(s) responsible for responding to the given project-related correspondence entry), when a response to the given project-related correspondence entry is due, and/or whether the subject of the given project-related correspondence entry may impact the given construction project's schedule, among other details.

As yet another example, the additional details may include a reference to source material, which may take various forms. For instance, the source material may include existing data that has been previously stored for the given construction project, examples of which may include digital project data (e.g., schedules, daily logs, images, drawings, specifications, correspondence, building information models (BIMs), sensor data, budgets, change orders, communications, invoices, directories, punch lists (e.g., which list work that has not yet been completed or has been completed incorrectly), timesheets, requests for information (RFIs), submittals, and/or reports, etc.), a prior project-related correspondence entry (which the given project-related correspondence entry may be responsive to), and/or existing project attributes (e.g., project title, project description, project type, etc.) that have been previously input by the given party, among other possible examples. The source material that may be referenced in the additional details included in the contents of the received request may take various other forms as well.

In practice, the received request may be initiated in various manners. As one possible implementation, the request may be initiated by the given user via front-end software running on a given client device (e.g., client device 104A, 104B, or 104C of FIG. 1), which may encode the request into a communication (e.g., one or more messages) and send it to the back-end computing platform 102 over a network-based communication path. The request may be initiated in various other manners well-including but not limited to the possibility that the request may be initiated in response to a trigger event rather than by the given user.

Further, the request may be initiated at any of various times. As one possibility, while accessing front-end software running on a given client device (e.g., client device 104A, 104B, or 104C of FIG. 1), the given user may input an indication to initiate the request to generate the given project-related correspondence entry, which may be accomplished by interacting with a user-interface view of the front-end client software, and that indication may cause the request to be initiated and sent to the back-end computing platform 102, which may provide it as input to the input interface 302 of the example software-based pipeline 300. As another possibility, the front-end or back-end software of the construction management software application may initiate the request to generate the given project-related correspondence entry in response to certain triggering events (e.g., assignment of a project-related correspondence entry to the given user). One of ordinary skill in the art would appreciate that the request to generate the given project-related correspondence entry may be initiated at various other times as well.

After the request to generate the given project-related correspondence entry is received by the input interface 302, the example software-based pipeline 300 may pass the received request to routing logic 304, which may function to determine whether to route the received request to either (i) an industry-level AI model 310 or (ii) a party-level AI model 312 for the given party. The routing logic 304 may make such determination in various manners.

As one possibility, the routing logic 304 may determine where to route the received request based on settings for the given party's account. For example, the settings for the given party's account may include a platform-defined setting set by the provider of the construction management software application that may permit or restrict the given party from having access to a party-level AI model. For instance, if the platform-defined setting permits the given party to have access to a party-level AI model, the routing logic 304 may determine to route the received request to the party-level AI model 312 for the given party. On the other hand, if the platform-defined setting only permits the given party to have access to the industry-level AI model 310, the routing logic 304 may determine to route the received request to the industry-level AI model 310.

In practice, whether the given party has access to a party-level AI model may depend on the given party's subscription plan for the construction management software application. For instance, if the given party has a subscription plan that allows for access to a party-level AI model for generating correspondence, the routing logic 304 may determine to route the received request to the party-level AI model 312. It should be understood, however, that whether the given party has access to a party-level AI model may depend on various other factors as well, which may be defined by the provider of the construction management software application.

As another example, the settings for the given party's account may include a preference-based setting that allows the given party to indicate which one of the disclosed types of AI models should be used to generate any given project-related correspondence entry. Accordingly, the routing logic 304 may determine where to route the received request based on this preference-based setting.

As another possibility, the routing logic 304 may determine where to route the received request based on settings for the given user associated with the given party. For example, the given user may have a permissions setting that is set by a representative of the given party which may permit or restrict the given user from having access to a party-level AI model. For instance, if the given user has been granted access to a party-level AI model for the given party, the routing logic 304 may determine to route the received request to the party-level AI model 312. On the other hand, if the given user has only been granted access to an industry-level AI model, the routing logic 304 may determine to route the received request to the industry-level AI model 310.

As another example, the settings for the given user may include a preference-based setting that allows the given user to indicate which one of the disclosed types of AI models should be used to generate any given project-related correspondence entry. Accordingly, the routing logic 304 may determine where to route the received request based on this preference-based setting.

As yet another possibility, the routing logic 304 may determine where to route the received request based on the contents of the received request. For example, the contents of the received request may include an indication that the given user wishes for a given type of AI model to be utilized to generate the given project-related correspondence entry, and the routing logic 304 may determine where to route the received request based on that indication.

The routing logic 304 may determine where to route the received request in various other manners as well.

If the routing logic 304 determines to route the received request to the industry-level AI model 310, the example software-based pipeline 300 may pass the received request to a prompt generator 306 for the industry-level AI model 310, which may function to generate a prompt for the industry-level AI model 310 comprising an instruction to generate a draft of the given project-related correspondence entry. This function of generating the prompt for the industry-level AI model 310 may take any of various forms.

For example, the function of generating the prompt for the industry-level AI model 310 may involve transforming the received request into a prompt for the industry-level AI model 310, which may comprise (i) an instruction for the industry-level AI model 310 to generate a draft of the given project-related correspondence entry for the given user that is associated with the given party, and (ii) input and/or context data that may provide additional information for the industry-level AI model 310 to utilize when generating the given project-related correspondence entry, among other possible components of the prompt for the industry-level AI model 310. Each of these components of the prompt may take various forms.

For instance, the instruction for the industry-level AI model 310 may inform the industry-level AI model 310 to either generate a new type of project-related correspondence entry or generate a project-related correspondence entry that is responsive to a prior project-related correspondence entry. In this respect, the instruction for the industry-level AI model 310 may take various forms. For example, the instruction may inform the industry-level AI model 310 to generate a new project-related correspondence entry regarding a notice (e.g., notice to proceed, notice of delay, etc.), an approval, request (e.g., an RFI, RFP, RFQ, change request, project progress request, extensions of time request, warranty request, etc.), or a status update, among any other type of project-related correspondence entry. As another example, the instruction may inform the industry-level AI model 310 to generate a response to a prior project-related correspondence entry regarding a notice, which may be identified in any of various ways, examples of which may include an identifier (e.g., an identification number) that corresponds to the prior project-related correspondence entry, the date the prior project-related correspondence entry was created, sent, and/or received, among other possibilities.

The instruction for the industry-level AI model 310 may take various other forms as well. For instance, in addition to informing the industry-level AI model 310 to either generate a new type of project-related correspondence entry or generate a project-related correspondence entry that is responsive to a prior project-related correspondence entry, the instruction may provide the industry-level AI model 310 with additional details about the project-related correspondence entry to be generated. For example, the instruction may inform the industry-level AI model 310 to generate a new type of project-related correspondence entry from the perspective of the given user's role in the given construction project (e.g., an assistant program manager role) and perhaps consider the roles of any given recipient that the given user plans to send the given project-related correspondence entry to. As another example, the instruction may inform the industry-level AI model 310 to generate a new type of project-related correspondence entry (or generate a project-related correspondence entry that is responsive to a prior project-related correspondence entry) with a particular goal (or set of goals), such as a goal to keep the contents of the entry brief as possible or as detailed as possible, among other possibilities.

It should be understood that while the instruction for the industry-level AI model 310 could provide the industry-level AI model 310 with additional details, such additional details could additionally or alternatively be provided as input and/or context data as discussed below. The instruction for the industry-level AI model 310 may take various other forms as well.

The input and/or context data included within the prompt may take various forms as well. For example, the input and/or context data may include similar details to those that were just discussed with respect to the instruction. As another example, the input and/or context data may include a reference to source material that is to be used when generating the project-related correspondence entry, such as digital project data and/or a prior project-related correspondence entry, among other source material that may provide the industry-level AI model 310 with additional information. In particular, a reference to source material may provide the industry-level AI model 310 with additional information to help it understand what the given user expects the given project-related correspondence entry to address and, in some instances where the input and/or context data includes a reference to a prior project-related correspondence entry, such input and/or context data could be used as a template for the industry-level AI model 310 to generate the given project-related correspondence entry. The input and/or context data may include other aspects and/or take other forms as well.

Further, the prompt may include other components and may take various other forms, and the function of generating the prompt for the industry-level AI model 310 may take various other forms as well.

The prompt generator's function of generating the prompt for the industry-level AI model 310 may take various other forms as well.

For example, in conjunction with transforming the received request into the prompt for the industry-level AI model 310, the prompt generator 306 may perform data cleaning operations on the contents included in the received request. The data cleaning operations may involve formatting the contents included in the received request to correct informalities, such as typographical and/or grammatical errors, linguistic inconsistencies, or the like.

As another example, in conjunction with transforming the received request into the prompt for the industry-level AI model 310, the prompt generator 306 may perform quality assessment operations to ensure that the contents of the received request will not cause the industry-level AI model 310 to generate the given project-related correspondence entry in a manner that would be unsatisfactory to the given user or the given party, which may entail the given project-related correspondence being generated in a manner that may include offensive language, irrelevant content, and/or content that would subject the given party to a potential legal and/or ethical violation. In this respect, the quality assessment operations may involve reviewing the contents included in the received request, identifying any potential issues that may cause the industry-level AI model 310 to generate the given project-related correspondence entry in a manner that would be unsatisfactory to the given user or the given party, and/or correcting these potential issues while transforming the received request into the prompt for the industry-level AI model 310.

The prompt generator 306 may perform various other operations as well.

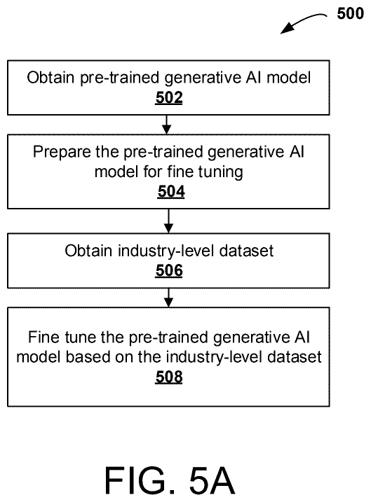

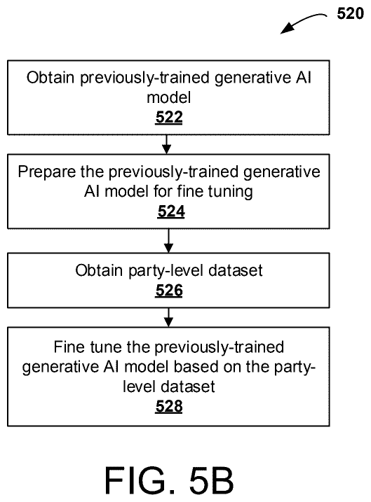

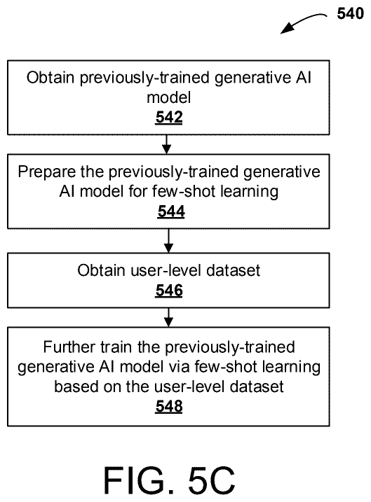

After the prompt generator 306 generates the prompt for the industry-level AI model 310, that prompt may be provided as input to the industry-level AI model 310, which as noted above may comprise an AI model that is created prior to execution of the example software-based pipeline 300 (e.g., via fine tuning of a pre-trained generative AI model, training of a generative AI model in the first instance, etc.). One possible example of functionality for creating the industry-level AI model 310 is described in further detail below with reference to FIG. 5A.

Based on the received prompt, the industry-level AI model 310 may then be executed to generate a draft of the given projected-related correspondence entry in accordance with terminology that is specific to the construction industry. As shown in FIG. 3, the draft of the given projected-related correspondence entry that is generated by the industry-level AI model 310 may then be passed to the output interface 320 of the example software-based pipeline 300, which will be described in further detail below.

On the other hand, if the routing logic 304 determines to route the received request to the party-level AI model 312, the example software-based pipeline 300 may pass the received request to a prompt generator 308 for the party-level AI model 312, which may function to generate a prompt for the party-level AI model 312 comprising an instruction to generate the draft of the given project-related correspondence entry. This function of generating the prompt for the party-level AI model 312 may take any of various forms.

For example, the function of generating the prompt for the party-level AI model 312 may involve transforming the received request into a prompt for the party-level AI model 312, which may comprise (i) an instruction for the party-level AI model 312 to generate a draft of the given project-related correspondence entry for the given user that is associated with the given party, and (ii) input and/or context data that may provide additional information for the party-level AI model 312 to utilize when generating the given project-related correspondence entry, among other possible components of the prompt for the party-level AI model 312. Each of these components of the prompt may take various forms similar to the forms discussed above with respect to the prompt for the industry-level AI model 310. The function of generating the prompt for the party-level AI model 312 may take various other forms as well.

It should also be understood that the prompt generator 308 may also perform various other operations similar to the prompt generator 306, such as the data cleaning operations and/or quality assessment operations discussed above. (It should also be understood that, in other embodiments where the industry-level AI model 310 and the party-level AI model 312 accept prompts having similar formats, the prompt generator 306 and prompt generator 308 could be combined together into a single prompt generator that generates prompts for both the industry-level AI model 310 and the party-level AI model 312).

After the prompt generator 308 generates the prompt for the party-level AI model 312, that prompt may be provided as input to the party-level AI model 312, which as noted above may comprise an AI model that is created prior to execution of the example software-based pipeline 300 (e.g., via fine tuning of a previously-trained generative AI model, training of a generative AI model in the first instance, etc.). One possible example functionality for creating the party-level AI model 312 is described in further detail below with reference to FIG. 5B.

Based on the received prompt, the party-level AI model 312 may then be executed to generate a draft of the given project-related correspondence entry in accordance with terminology that is specific to the given party. As shown, the draft of the given project-related correspondence entry that is generated by the party-level AI model 312 for the given party may then be passed to the routing logic 314, which may function to determine whether to route the generated draft of the given project-related correspondence entry to either (i) a user-level AI model 318 for the given user or (ii) the output interface 320. The routing logic 314 may make such determination in various manners.

As one possibility, the routing logic 314 may determine where to route the generated draft of the given project-related correspondence entry based on the settings for the given party's account. For example, the settings for the given party's account may include a platform-defined setting set by the provider of the construction management software application that may permit or restrict users of the given party from having access to user-level AI models. Depending on this platform-defined setting, the routing logic 304 may determine whether to route the generated draft of the given project-related correspondence entry to the user-level AI model 318 or the output interface 320.

In line with the discussion above, in practice, whether the given party's users have access to user-level AI models may depend on the given party's subscription plan for the construction management software application. For instance, if the given party has a subscription plan that allows for access to user-level AI models, the routing logic 314 may determine to route the generated draft of the given project-related correspondence entry to the user-level AI model 318. It should be understood, however, that whether the given party's users have access to user-level AI models may depend on various other factors as well, which may be defined by the provider of the construction management software application.

As another example, the settings for the given party's account may include a preference-based setting that allows the given party to indicate which one of the disclosed types of AI models should be executed to generate any given project-related correspondence entry. Accordingly, the routing logic 314 may determine where to route the generated draft of the given project-related correspondence entry based on this preference-based setting.

As another possibility, the routing logic 314 may determine where to route the generated draft of the given project-related correspondence entry based on settings for the given user associated with the given party. For example, in line with the discussion above, the given user may have a permissions setting that is set by a representative of the given party that may permit or restrict the given user from accessing a user-level AI model. For instance, if the given user has been granted access to a user-level AI model, the routing logic 314 may determine to route the generated draft of the given project-related correspondence entry to the user-level AI model 318. On the other hand, if the given user has not been granted access to a user-level AI model, the routing logic 314 may determine to route the generated draft of the given project-related correspondence entry to the output interface 320.

As another example, the settings for the given user may include a preference-based setting that allows the given user to indicate that a user-level AI model should be executed to generate any given project-related correspondence entry. Accordingly, the routing logic 314 may determine where to route the generated draft of the given project-related correspondence entry based on this preference-based setting.

As yet another possibility, the routing logic 314 may determine where to route the generated draft of the given project-related correspondence entry based on the contents of the received request. For example, the contents of the received request may include an indication that the given user wishes for a user-level AI model to be utilized to generate the given project-related correspondence entry, and the routing logic 314 may determine where to route the generated draft of the given project-related correspondence entry based on that indication.

The routing logic 314 may determine where to route the generated draft of the given project-related correspondence entry in various other manners as well.

If the routing logic 314 determines to route the generated draft of the given project-related correspondence entry to the user-level AI model 318, the example software-based pipeline 300 may pass the draft of the given project-related correspondence entry to a prompt generator 316 for the user-level AI model 318, which may function to generate a prompt for the user-level AI model 318. This function of generating the prompt for the user-level AI model 318 may take any of various forms.

For example, the function of generating the prompt for the user-level AI model 318 may involve generating a prompt for the user-level AI model 318 based on the draft of the given project-related correspondence entry, where the prompt may comprise (i) an instruction for the user-level AI model 318 to update the generated draft of the given project-related correspondence entry, (ii) the draft of the given project-related correspondence entry (or a reference thereto), and perhaps also (iii) other input and/or context data that may provide additional information for the user-level AI model 318 to utilize when updating the draft of the given project-related correspondence entry. Each of these components of the prompt may take various forms.

For instance, the instruction for the user-level AI model 318 may inform the user-level AI model 318 to update the draft of the given project-related correspondence entry in accordance with terminology that is specific to the given user. Additionally, in some implementations, the instruction may provide the user-level AI model 318 with additional details similar to the additional details discussed above with respect to the instruction for the industry-level AI model 310. It should be understood, however, that while the instruction for the user-level AI model 318 could provide the user-level AI model 318 with additional details, such additional details could additionally or alternatively be provided as input and/or context data for the user-level AI model 318 as discussed below. The instruction for the user-level AI model 318 may take various other forms as well.

The other input and/or context data included within the prompt may take various forms as well. For example, the other input and/or context data may include a reference to source material (e.g., digital project data and/or a prior project-related correspondence entry, among other examples) that may provide the user-level AI model 318 with additional information for updating the draft of the given project-related correspondence entry in accordance with terminology that is specific to the given user. The input and/or context data may include other aspects and/or take other forms as well.

Further, the prompt may include other components and may take various other forms, and the function of generating the prompt for the user-level AI model 318 may take various other forms as well. It should also be understood that the prompt generator 316 may perform various other operations similar to the prompt generator 306, such as the data cleaning operations and/or quality assessment operations discussed above.

After the prompt generator 316 generates the prompt for the user-level AI model 318, that prompt may be provided as input to the user-level AI model 318, which as noted above may comprise an AI model that is created prior to execution of the example software-based pipeline 300 (e.g., via few-shot learning of a previously-trained generative AI model, training of a generative AI model in the first instance, etc.). One possible example of functionality for creating the user-level model 308 is described below with reference to FIG. 5C, but at a high level, the function of further training the user-level AI model 318 via few-shot learning may involve providing a previously-trained generative AI model (e.g., an industry-level AI model, a party-level AI model, or a pre-trained generative AI model which may not have been further trained with industry-level dataset or party-level dataset) with a few-shot dataset comprising examples of project-related correspondence entries drafted in accordance with terminology that is specific to the given user and thereby causing the previously-trained generative AI model to learn from the examples so as to produce the user-level AI model 318. In practice, the few-shot dataset may be provided to the previously-trained model in the form of a prompt, which could either be (i) separate from the prompt generated by the prompt generator 316 (e.g., a system prompt that precedes the prompt generated by the prompt generator 316), in which case the user-level AI model 318 may be trained prior to being executed, or (ii) the same as the prompt generated by the prompt generator 316 (e.g., the few-shot dataset may be included as part of the prompt generated by the prompt generator 316), in which case the user-level AI model 318 may be trained and executed based on the same prompt.

Based on the received prompt, the user-level AI model 318 may then be executed to generate an updated draft of the given correspondence entry in accordance with terminology that is specific to the given user. As shown, the updated draft of the given projected-related correspondence entry that is generated by the user-level AI model 318 may then be passed to the output interface 320 of the example software-based pipeline 300.

After the output interface 320 receives a draft of the given project-related correspondence entry from one of the disclosed AI models as discussed above, the output interface 320 may cause the draft of the given project-related correspondence entry to be presented to the given user via a given client device (e.g., client device 104A, 104B, or 104C of FIG. 1), which may enable the given user to view and/or interact with the draft of the given project-related correspondence entry. In practice, this function may involve causing the back-end computing platform 102 to send the draft of the given project-related correspondence entry to the given client device over a network-based communication path in the form of one or more messages that could be encoded in a format such as HTML, JSON, or the like. In at least some implementations, the one or more messages may be sent via one or more APIs.

Further, in practice, the output interface 320 may cause the draft of the given project-related correspondence entry to be presented to the given user in response to the draft being generated by a given AI model and passed to the output interface 320. It should be understood, however, that the output interface 320 may cause the draft of the given project-related correspondence entry to be presented to the given user via the given client device at any of various times, including periodically and/or in response to certain triggering events (e.g., after a given AI model is executed, after receiving a request to access the given project-related correspondence entry that has been generated, etc.), among other possibilities.

The output interface 320 (or some other component of the example software-based pipeline 300) may further be configured to store the draft of the given project-related correspondence entry within a data storage layer of the back-end computing platform 102. The output interface 320 (or some other component of the back-end platform 102) may then be able to later access the stored draft of the given project-related correspondence entry and cause the stored draft to be presented to the given user.

Although not shown, before the output interface 320 (or some other component of the back-end platform 102) causes the draft of the given project-related correspondence entry to be presented to the given user, the example software-based pipeline 300 may include a quality assessment component that reviews the draft of the given project-related correspondence output by a given type of AI model to ensure that the draft complies with a set of standards (e.g., ethical and/or legal standards) that may be set by the provider of the construction management software application and/or the given party. In this regard, the quality assessment component may ensure that the draft of the given project-related correspondence does not contain any content that may include offensive language and/or language that could subject the given party to a potential legal and/or ethical violation.

The example software-based pipeline 300 may include various other components that function to perform operations before the output interface 320 (or some other component of the back-end platform 102) causes the draft of the given project-related correspondence entry to be presented to the given user.

After the output interface 320 (or some other component of the back-end platform 102) causes the draft of the given project-related correspondence entry to be presented to the given user via the given client device, the given user may utilize the given client device to interact with the draft of the given project-related correspondence entry, such as by reviewing and perhaps also providing user feedback on the draft of the given project-related correspondence entry in the form of revisions or the like. Generally speaking, such user interaction with the draft of the given project-related correspondence entry may be informative in determining the quality of the draft, and the user interaction may be used by the example software-based pipeline 300 to further refine one or more of the disclosed AI models, thereby improving the quality of future project-related correspondence generated by the one or more disclosed AI models. For instance, although not shown, the example software-based pipeline 300 may further include a reward model that is configured to (i) receive, as input, data defining the given user's interactions with the draft of the given project-related correspondence entry, (ii) generate a “reward” value (or “score” value) for the draft of the given project-related correspondence entry based on the given user's interactions, and (iii) feed the reward value back to at least one of the AI models involved in generating the draft of the given project-related correspondence entry, which may then use the reward value to refine its generation of project-related correspondence entries going forward. This functionality is commonly referred to as reinforcement learning with human feedback (RLHF).

The data defining the given user's interactions with the draft of the given project-related correspondence entry may take any of various forms. As one example, the data defining the given user's interactions with the draft of the given project-related correspondence entry may comprise data that provides information about the given user's revisions to the draft of the given project-related correspondence entry, such as the extent of the revisions, the nature of the revisions, the length of time spent revising, or a summary of the revisions themselves (e.g., a redline-type comparison between the initial and revised draft), among other possibilities. As another example, the data defining the given user's interactions with the draft of the given project-related correspondence entry may comprise a user rating of the quality of the draft (e.g., a rating provided via a thumbs up/down scale or a numerical scale represented by stars or the like). The data defining the given user's interactions with the draft of the given project-related correspondence entry may take other forms as well.

Further, the manner in which a given one of the AI models utilizes the reward values to refine its generation of project-related correspondence entries may take any of various forms. As one possibility, the given AI model may comprise a policy that forms the basis for the model's decision-making regarding generation of project-related correspondence entries, and the given AI model may refine this policy based on the reward values using a technique such as proximal policy optimization (PPO) (among other possibilities). In this respect, the given AI model may be configured to refine its policy based on each individual reward value that is generated by the reward model, or may be configured to refine its policy based on batches of multiple rewards values that are generated by the reward model, among other possibilities

Further yet, the reward model may comprise any type of data science model that is configured to generate reward values for project-related correspondence entries based on user interaction, examples of which may comprise any of various types of AI models that may be trained and/or fine-tuned using machine-learning techniques such as supervised, self-supervised, and/or unsupervised learning.

Still further, if the user interactions take the form of user ratings of the quality of the project-related correspondence generated by an AI model, then the AI model may be capable of using those user ratings to refine its generation of project-related correspondence entries without requiring the use of a reward model.

The function of refining one or more of the disclosed AI models based on user interaction with the project-related correspondence entries generated by the one or more models may take various other forms as well.

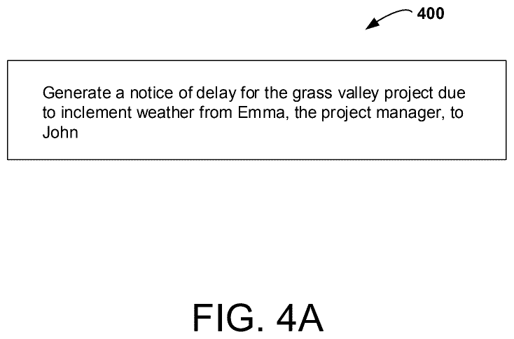

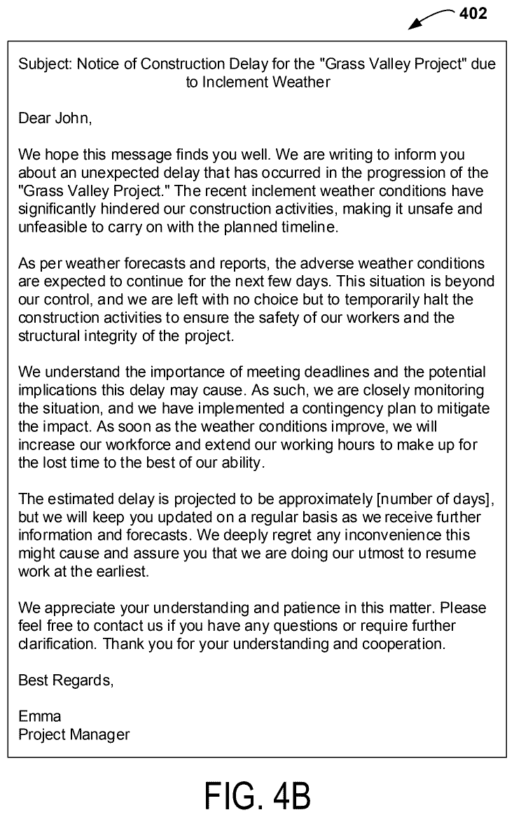

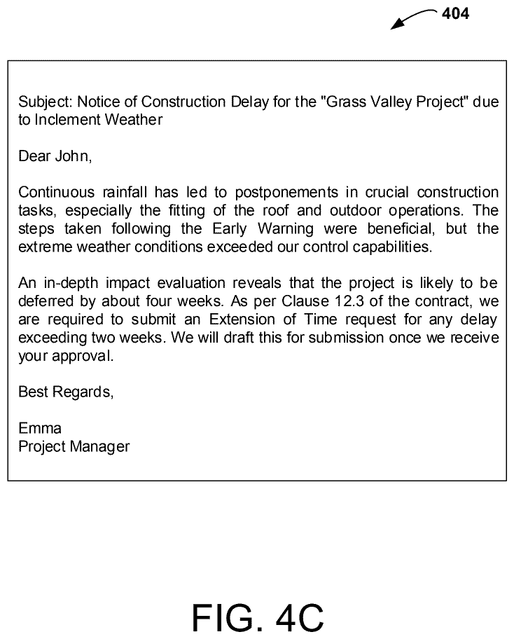

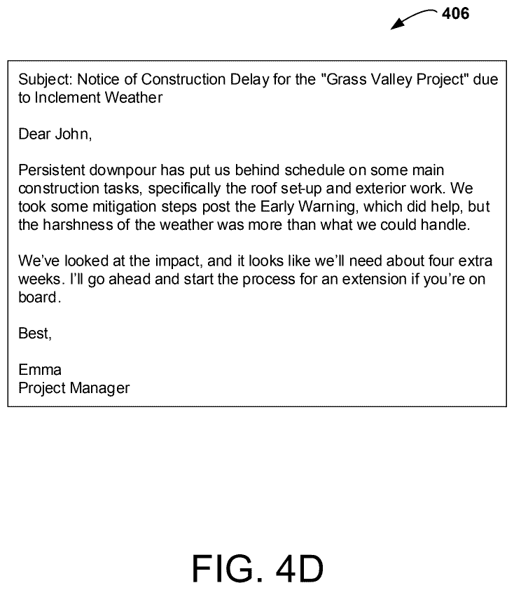

Aspects of the functionality discussed above will now be illustrated with reference to FIGS. 4A-4D.

To begin, FIG. 4A depicts example content 400 that a given user may include in a request for generating a project-related correspondence entry that is received by the disclosed software pipeline (e.g., the example software-based pipeline 300). As shown, the example content 400 may comprise various information, including an indication to create a new project-related correspondence entry that provides notice of a delay for a given construction project, and (2) additional details that include information about the sender and recipient of the new project-related correspondence entry. In turn, the disclosed software-based pipeline may generate a draft of the new project-related correspondence entry using one or more types of AI models and then cause the draft to be presented to the given user. As discussed above, the draft of the new project-related correspondence entry may take various forms, which may depend on which one or more of the disclosed types of AI models is used to generate the draft.

To illustrate, FIG. 4B shows a first example 402 of a draft of the new project-related correspondence entry that may be generated by an industry-level AI model (e.g., the industry-level AI model 310) in accordance with terminology that is specific to the construction industry (e.g., terms that are commonly used by professionals in the construction industry), FIG. 4C shows a second example 404 of a draft of the new project-related correspondence entry that may be generated by a party-level AI model (e.g., the party-level AI model 312) in accordance with terminology that is specific to a given party associated with the given user (e.g., terms that are commonly used by the given party's users in project-related correspondence), and FIG. 4D shows a third example 406 of a draft of the new project-related correspondence entry that may first be generated by a party-level AI model (e.g., the party-level AI model 312) in accordance with terminology that is specific to a given party associated with the given user and may then be updated by a user-level AI model (e.g., the user-level AI model 318) in accordance with terminology that is specific to the given user (e.g., terms that are commonly used by the given user in in project-related correspondence).

As shown, unlike the first example 402 that may be generated by an industry-level AI model, the second example 404 that may be generated by a party-level AI model may have terminology that is specific to a given party associated with the given user, such as a reference to a particular contract provision (e.g., “Clause 12.3 of the contract”) of the given party and a reference to the given party's project schedule and an estimate of the project's scheduling impact based on the delay (e.g., “the project is likely to be deferred by about four weeks”). Similarly, the third example 406 that may be updated by a user-level AI model in accordance with terminology that is specific to the given user includes a reference to an estimate of the project's scheduling impact based on the delay (“it looks like we'll need about four extra weeks”), but the draft of the new project-related correspondence entry includes terminology that is more specific to the given user, including the use the given user's closing salutation (e.g., “Best”) instead of a more generic closing salutation that may be specific to the given party or the construction industry.

Turning now to FIGS. 5A-5C, some example flow charts are shown to illustrate example functionality for creating the types of AI models that are utilized by the software-based pipeline disclosed herein. In practice, the example functionality for creating the AI models may be encoded in the form of program instructions that are executable by one or more processors of a computing platform, and for purposes of illustration, the example functionality for creating the AI models is described as being carried out by the back-end computing platform 102 of FIG. 1, but it should be understood that the example functionality for creating the AI models may be carried out by any one or more computing platforms that are capable of performing the example functionality for creating the AI models. Further, it should be understood that the example functionality for creating the AI models is merely described in this manner for the sake of clarity and explanation and that the example functionality may be implemented in various other manners, including the possibility that functions may be added, removed, rearranged into different orders, combined into fewer blocks, and/or separated into additional blocks depending upon the particular embodiment.

FIG. 5A shows a flow chart that illustrates example functionality 500 for creating an industry-level AI model (e.g., the industry-level AI model 310 of FIG. 3) in accordance with the present disclosure. In this example, the industry-level AI model is described to take the form of a pre-trained generative AI model that is further trained via fine tuning to generate correspondence in accordance with terminology that is specific to the construction industry, but as discussed above, the industry-level AI model could take other forms as well.

As shown in FIG. 5A, the example functionality 500 for creating an industry-level AI model may begin at block 502 with the back-end computing platform 102 obtaining a pre-trained generative AI model to use as the starting point for the industry-level AI model. Such a pre-trained generative AI model may take any of various forms, including but not limited to any of the example types of pre-trained generative AI models discussed above (e.g., an “off-the-shelf” generative AI model, such as a GPT type of generative AI model, a BERT type of generative AI model, a T5 type of generative AI model, a PEGASUS type of generative AI model, a Llama type of generative AI model, or Phi-2 or Phi-3 type of generative AI model, among other examples).

At block 504, the back-end computing platform 102 may prepare the pre-trained generative AI model for fine tuning. The function of preparing the pre-trained generative AI model for fine tuning may involve any of various operations, examples of which may include modifying, freezing, and/or unfreezing certain layers of the pre-trained generative AI model and/or adjusting the architecture of the pre-trained generative AI model in other ways.

At block 506, the back-end computing platform 102 may obtain a dataset for use in fine tuning the pre-trained generative AI model so as to produce the industry-level AI model, which may be referred to herein as an “industry-level dataset.” In general, such an industry-level dataset may comprise an industry-level set of “ground-truth” project-related correspondence entries drafted in accordance with terminology that is specific to the construction industry, perhaps along with corresponding prompts comprising instructions (and/or other data) for generating such project-related correspondence entries. This industry-level set of ground-truth project-related correspondence entries may include historical project-related correspondence entries that were previously created by various different users of various different parties within the construction management software application and/or synthetic project-related correspondence entries that were specifically created for the purpose of fine tuning the pre-trained generative AI model so as to produce the industry-level AI model, among other possibilities.

At block 508, the back-end computing platform 102 may fine tune the pre-trained generative AI model based on the industry-level dataset and thereby adjust the parameters of the pre-trained generative AI model so as produce the industry-level AI model. The back-end computing platform 102 may carry out this fine tuning using any of various fine-tuning techniques, including but not limited to any of various supervised fine-tuning techniques, examples of which may include a full fine-tuning technique and/or a parameter efficient fine-tuning (PEFT) technique (e.g., low-rank adaption, selective fine tuning, additive fine turning, etc.), among other possibilities.

In some implementations, the back-end computing platform 102 may be configured to carry out a single iteration of the foregoing functionality 500 in order to produce a single industry-level AI model. Alternatively, in other implementations, the back-end computing platform 102 may be carry out multiple iterations of the foregoing functionality 500 using different fine-tuning strategies (e.g., different hyperparameters, different loss functions, different techniques, etc.) in order to produce multiple different “candidate” industry-level AI models, in which case the back-end computing platform 102 may then select a given one of those candidate industry-level AI models to utilize as the industry-level AI model within the disclosed software-based pipeline. To accomplish this, the back-end computing platform 102 may evaluate the performance of the candidate industry-level AI models utilizing a validation dataset (or sometimes referred to as a “test dataset”) comprising ground-truth project-related correspondence entries along with corresponding prompts.

The functionality for creating an industry-level AI model in accordance with the present disclosure may take various other forms as well.

Next, FIG. 5B shows a flow chart that illustrates example functionality 520 for creating a party-level AI model for a given party (e.g., the party-level AI model 312 of FIG. 3) in accordance with the present disclosure. In this example, the party-level AI model is described to take the form of a previously-trained generative AI model (e.g., an industry-level AI model or a pre-trained generative AI model which may not have been further trained with industry-level dataset) that is further trained via fine tuning to generate correspondence in accordance with terminology that is specific to the given party, but as discussed above, the party-level AI model could take other forms as well.

As shown in FIG. 5B, the example functionality 520 for creating a party-level AI model may begin at block 522 with the back-end computing platform 102 obtaining a previously-trained generative AI model to use as the starting point for the party-level AI model. Such a previously-trained generative AI model may take any of various forms, including but not limited to an industry-level AI model that was further trained with industry-level dataset or any of the example types of pre-trained generative AI models discussed above (e.g., an “off-the-shelf” generative AI model, such as a GPT type of generative AI model, a BERT type of generative AI model, a T5 type of generative AI model, a PEGASUS type of generative AI model, a Llama type of generative AI model, or Phi-2 or Phi-3 type of generative AI model, among other examples).

At block 524, the back-end computing platform 102 may prepare the previously-trained generative AI model for fine tuning. The function of preparing the previously-trained generative AI model for fine tuning may involve any of various operations, examples of which may include modifying, freezing, and/or unfreezing certain layers of the previously-trained generative AI model and/or adjusting the architecture of the previously-trained generative AI model in other ways.

At block 526, the back-end computing platform 102 may obtain a dataset for use in fine tuning the previously-trained generative AI model so as to produce the party-level AI model, which may be referred to herein as an “party-level dataset.” In general, such a party-level dataset may comprise a party-level set of “ground-truth” project-related correspondence entries drafted in accordance with terminology that is specific to the given party, perhaps along with corresponding prompts comprising instructions (and/or data) for generating such project-related correspondence entries. This party-level set of ground-truth project-related correspondence entries may include historical project-related correspondence entries that were previously created by users of the given party within the construction management software application and/or synthetic project-related correspondence entries that were specifically created for the purpose of fine tuning the previously-trained generative AI model so as to produce the party-level AI model, among other possibilities.

At block 528, the back-end computing platform 102 may fine tune the previously-trained generative AI model based on the party-level dataset and thereby adjust the parameters of the previously-trained generative AI model so as to produce the party-level AI model. The back-end computing platform 102 may carry out this fine tuning using any of various fine-tuning techniques, including but not limited to any of various supervised fine-tuning techniques, examples of which may include a full fine-tuning technique and/or a PEFT technique (e.g., low-rank adaption, selective fine tuning, additive fine turning, etc.), among other possibilities.

In some implementations, the back-end computing platform 102 may be configured to carry out a single iteration of the foregoing functionality 520 in order to produce a single party-level AI model. Alternatively, in other implementations, the back-end computing platform 102 may be carry out multiple iterations of the foregoing functionality 520 using different fine-tuning strategies (e.g., different hyperparameters, different loss functions, different techniques, etc.) in order to produce multiple different “candidate” party-level AI models, in which case the back-end computing platform 102 may then select a given one of those candidate party-level AI models to utilize as the party-level AI model within the disclosed software-based pipeline. To accomplish this, the back-end computing platform 102 may evaluate the performance of the candidate party-level AI models utilizing a validation dataset (or sometimes referred to as a “test dataset”) comprising ground-truth project-related correspondence entries along with corresponding prompts.

The functionality for creating a party-level AI model in accordance with the present disclosure may take various other forms as well.

Lastly, FIG. 5C shows a flow chart that illustrates example functionality 540 for creating a user-level AI model for a given user (e.g., the user-level AI model 318 of FIG. 3) in accordance with the present disclosure. In this example, the user-level AI model is described to take the form of a previously-trained generative AI model (e.g., an industry-level AI model, a party-level AI model, or a pre-trained generative AI model which may not have been further trained with industry-level dataset or party-level dataset) that is further trained via few-shot learning (sometimes also referred to as few-shot prompting or in-context learning) to generate correspondence in accordance with terminology that is specific to the given user, but as discussed above, the user-level AI model could take other forms as well.

As shown in FIG. 5C, the example functionality 540 for creating a user-level AI model may begin at block 542 with the back-end computing platform 102 obtaining a previously-trained generative AI model to use as the starting point for the user-level AI model. Such a previously-trained generative AI model may take any of various forms, including but not limited to an industry-level AI model that was further trained with industry-level dataset, a party-level AI model that was further trained with party-level dataset, or any of the example types of pre-trained generative AI models discussed above (e.g., an “off-the-shelf” generative AI model, such as a GPT type of generative AI model, a BERT type of generative AI model, a T5 type of generative AI model, a PEGASUS type of generative AI model, a Llama type of generative AI model, or Phi-2 or Phi-3 type of generative AI model, among other examples).

At block 544, the back-end computing platform 102 may prepare the previously-trained generative AI model for few-shot learning. The function of preparing the previously-trained generative AI model for few-shot learning may involve any of various operations, examples of which may include adjusting the architecture of the previously-trained generative AI model so as to allow for few-shot learning.

At block 546, the back-end computing platform 102 may obtain a dataset for use in further training the previously-trained model via few-shot learning so as to produce the user-level AI model, which may be referred to herein as an “user-level dataset.” In general, such a user-level dataset may comprise a user-level set of “ground-truth” project-related correspondence entries drafted in accordance with terminology that is specific to the given user, perhaps along with corresponding prompts comprising instructions (and/or data) for generating such project-related correspondence entries. This user-level set of ground-truth project-related correspondence entries may include historical project-related correspondence entries that were previously created by users of the given user within the construction management software application and/or synthetic project-related correspondence entries that were specifically created for the purpose of applying few-shot learning to the previously-trained generative AI model so as to produce the user-level AI model, among other possibilities. Further, because the user-level AI model is produced using few-shot learning rather than fine tuning, the user-level set of ground-truth project-related correspondence entries may generally include a much smaller number of correspondence entries (e.g., less than 10 entries) than the industry-level or party-level sets of ground-truth project-related correspondence entries discussed above.

At block 548, the back-end computing platform 102 may further train the previously-trained generative AI model via few-shot learning based on the user-level dataset so as to produce the user-level AI model. The back-end computing platform 102 may carry out this further training using any of various few-shot-learning techniques, including but not limited to transfer-learning, meta-learning, and/or data-level techniques, among other possibilities. Further, the function of further training the previously-trained generative AI model via few-shot learning may involve providing the user-level dataset to the previously-trained generative AI model as part of a prompt (e.g., a system prompt or an input prompt), which may then cause the previously-trained generative AI model to learn from the user-level dataset and thereby produce the user-level AI model. Further yet, in practice, the knowledge that is learned via few-shot learning may only be retained for some temporary period of time during which the user-level AI model is being utilized to produce the updated draft of the given project-related correspondence for the given user, and once that task is complete, the user-level AI model that is produced via few-shot learning may cease to exist (i.e., the user-level AI model may effectively “revert” back to the previously-trained generative AI model).

The functionality for creating a user-level AI model in accordance with the present disclosure may take various other forms as well.

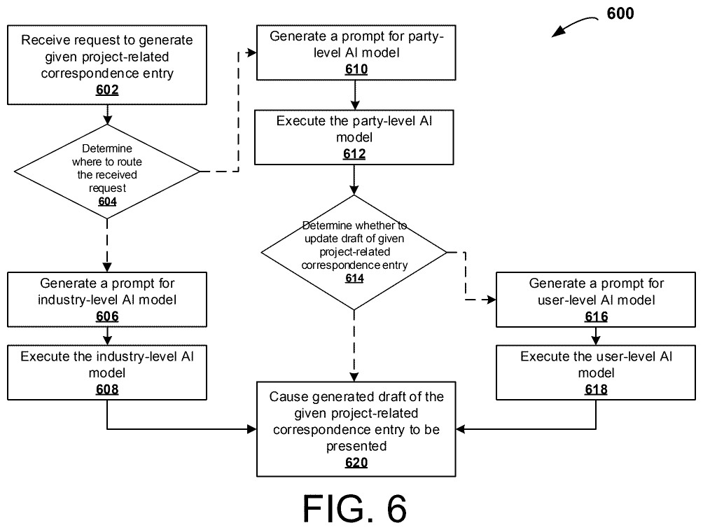

Turning now to FIG. 6, a flow diagram 600 is depicted showing an example process that may be carried out in accordance with the disclosed software-based pipeline for generating project-related correspondence. In practice, the functions of the flow diagram 600 may be carried out by a back-end computing platform (e.g., the back-end computing platform 102 of FIG. 1), but it should be understood that some or all of the functions of flow diagram 600 may be carried out by any one or more computing platforms that are capable of performing such functions. Further, it should be understood that the flow diagram 600 is merely described in this manner for the sake of clarity and explanation and that the example functions described may be implemented in various other manners, including the possibility that functions may be added, removed, rearranged into different orders, combined into fewer blocks, and/or separated into additional blocks depending upon the particular embodiment.

Starting at block 602, the disclosed software-based pipeline may receive a request to generate a given project-related correspondence entry for a given user that is associated with a given party. In line with the previous discussion with respect to the example software-based pipeline 300, the contents of the received request to generate the given project-related correspondence entry may take various forms, and the request may be initiated at any of various times.

At block 604, the disclosed software-based pipeline may determine whether to route the received request to either (i) an industry-level AI model (e.g., the industry-level AI model 310) or (ii) a party-level AI model (e.g., the party-level AI model 312) for the given party. In line with the previous discussion with respect to the routing logic 304, the disclosed software-based pipeline may make such determination in various manners.

If the disclosed software-based pipeline determines to route the received request to the industry-level AI model, then at block 606, the disclosed software-based pipeline may generate a prompt for the industry-level AI model comprising an instruction to generate a draft of the given project-related correspondence entry, among various other components in line with the discussion above with respect to the prompt generator 306 for the industry-level AI model 310. As discussed above, this function of generating the prompt for the industry-level AI model may take any of various forms, and it should be understood that the disclosed software-based pipeline may perform various other operations while generating the prompt for the industry-level AI model as well. After the prompt for the industry-level AI model is generated, that prompt may be provided as input to the industry-level AI model, and at block 608, the industry-level AI model may then be executed to generate a draft of the given projected-related correspondence entry in accordance with terminology that is specific to the construction industry. As shown, at block 620, the disclosed software-based pipeline may cause the draft of the given projected-related correspondence entry to be presented to the given user by sending the generated draft to the given user's client device over a network-based communication path.

On the other hand, if the disclosed software-based pipeline determines to route the received request to the party-level AI model, then at block 610, the disclosed software-based pipeline may generate a prompt for the party-level AI model comprising an instruction to generate a draft of the given project-related correspondence entry, among various other components in line with the discussion above with respect to the prompt generator 308 for the party-level AI model 312. As discussed above, this function of generating the prompt for the party-level AI model may take any of various forms, and it should be understood that the disclosed software-based pipeline may perform various other operations while generating the prompt for the party-level AI model as well. After the prompt for the party-level AI model is generated, that prompt may be provided as input to the party-level AI model, and at block 612, the party-level AI model may then be executed to generate a draft of the given projected-related correspondence entry in accordance with terminology that is specific to the given party.

At block 614, the disclosed software-based pipeline may then determine whether to either (i) update the draft of the given project-related correspondence entry generated by the party-level AI model using a user-level AI model for the given user or (ii) cause the draft of the given project-related correspondence entry generated by the party-level AI model to be presented to the given user via a client device. In line with the discussion above with respect to the routing logic 314, the disclosed software-based pipeline may make such determination in various manners.

If the disclosed software-based pipeline determines at block 614 to update the draft of the given project-related correspondence entry generated by the party-level AI model using a user-level AI model for the given user, then at block 616, the disclosed software-based pipeline may generate a prompt for the user-level AI model comprising an instruction to generate an updated draft of the given project-related correspondence entry, among various other components in line with the discussion above with respect to the prompt generator 316 for the user-level AI model 318. As discussed above, this function of generating the prompt for the user-level AI model may take any of various forms, and it should be understood that the disclosed software-based pipeline may perform various other operations while generating the prompt for the user-level AI model as well. After the prompt for the user-level AI model is generated, that prompt may be provided as input to the user-level AI model (perhaps along with a few-shot dataset for training the user-level AI model), and at block 618, the user-level AI model may then be executed to generate an updated draft of the given project-related correspondence entry in accordance with terminology that is specific to the given user. In turn, at block 620, the disclosed software-based pipeline may cause the updated draft of the given projected-related correspondence entry to be presented to the given user's client device.

On the other hand, if the disclosed software-based pipeline determines at block 614 to cause the draft of the given project-related correspondence entry generated by the party-level AI model to be presented to the given user via a client device, then at block 620, the disclosed software-based pipeline may cause the draft of the given project-related correspondence entry generated by the party-level AI model to be presented to the given user's client device.

Although not shown, after the disclosed software-based pipeline causes a generated draft of the given projected-related correspondence entry to be presented to the given user's client device, the disclosed software-based pipeline may function to receive data indicating the given user's interaction with the draft of the given projected-related correspondence entry and refine one or more of the disclosed types of AI models based on the given user's interaction in line with the discussions above.

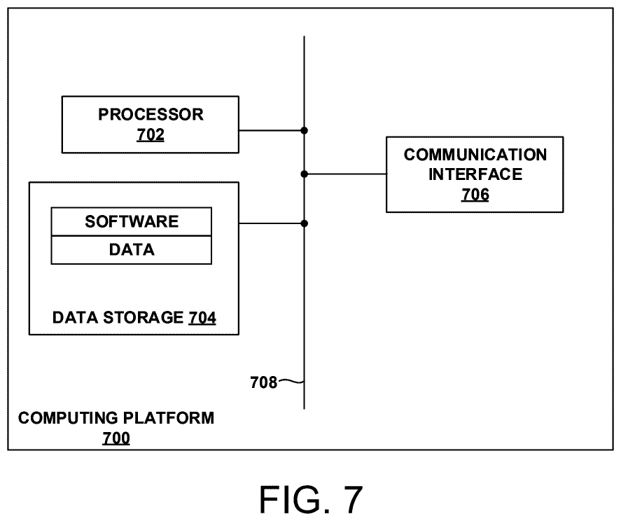

Turning now to FIG. 7, a simplified block diagram is provided to illustrate some structural components that may be included in an example computing platform 700 that may be configured to perform the platform-side functions disclosed herein. At a high level, the example computing platform 700 may generally comprise any one or more computer systems (e.g., one or more servers) that collectively include one or more processors 702, data storage 704, and one or more communication interfaces 706, each of which may be communicatively linked by a communication link 708 that may take the form of a system bus, a communication network such as a public, private, or hybrid cloud, or some other connection mechanism. Each of these components may take various forms.

For instance, the one or more processors 702 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 702 could comprise processing components that are distributed across a plurality of physical computing devices connected via a network, such as a computing cluster of a public, private, or hybrid cloud.

In turn, the data storage 704 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 704 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 7, the data storage 704 may be capable of storing both (i) program instructions that are executable by the one or more processors 702 such that the example computing platform 700 is configured to perform any of the various functions disclosed herein (including but not limited to any of the platform-side functions discussed above), and (ii) data that may be received, derived, or otherwise stored by the example computing platform 700.

The one or more communication interfaces 706 may comprise one or more interfaces that facilitate communication between the example computing platform 700 and other systems or devices, where each such interface may be wired and/or wireless and may communicate according to any of various communication protocols. As examples, the one or more communication interfaces 706 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 700 may additionally have an Input/Output (I/O) interface that includes or provides connectivity to I/O components that facilitate user interaction with the example computing platform 700, such as a keyboard, a mouse, a trackpad, a display screen, a touch-sensitive interface, a stylus, a virtual-reality headset, and/or one or more speaker components, among other possibilities.

It should be understood that the example computing platform 700 is one example of a computing platform that may be used with the examples described herein. Numerous other arrangements are possible and contemplated herein. For instance, in other examples, the example computing platform 700 may include additional components not pictured and/or more or less of the pictured components.

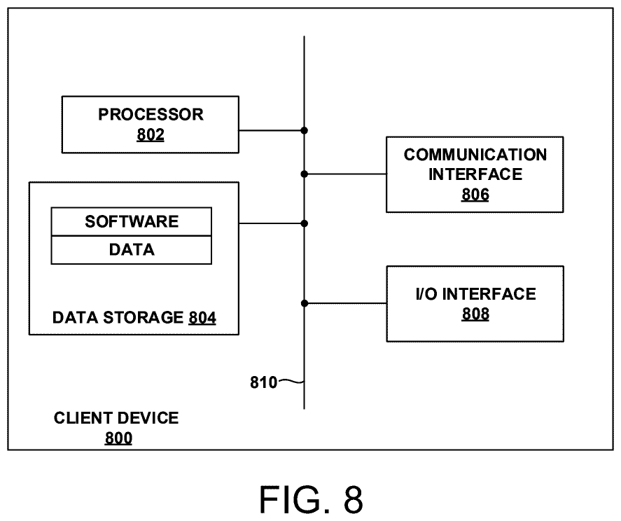

Turning next to FIG. 8, a simplified block diagram is provided to illustrate some structural components that may be included in an example client device 800 that may be configured to perform some the client-side functions disclosed herein. At a high level, the example client device 800 may include one or more processors 802, data storage 804, one or more communication interfaces 806, and an I/O interface 808, each of which may be communicatively linked by a communication link 810 that may take the form a system bus and/or some other connection mechanism. Each of these components may take various forms.

For instance, the one or more processors 802 of the example client device 800 may comprise one or more processor components, such as one or more CPUs, GPUs, ASICs, DSPs, and/or programmable logic devices such as FPGAs, among other possible types of processing components.

In turn, the data storage 804 of the example client device 800 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 8, the data storage 804 may be capable of storing both (i) program instructions that are executable by the one or more processors 802 of the example client device 800 such that the example client device 800 is configured to perform any of the various functions disclosed herein (including but not limited to any of the client-side functions discussed above), and (ii) data that may be received, derived, or otherwise stored by the example client device 800.

The one or more communication interfaces 806 may comprise one or more interfaces that facilitate communication between the example client device 800 and other systems or devices, where each such interface may be wired and/or wireless and may communicate according to any of various communication protocols. As examples, the one or more communication interfaces 806 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 808 may generally take the form of (i) one or more input interfaces that are configured to receive and/or capture information at the example client device 800 and (ii) one or more output interfaces that are configured to output information from the example client device 800 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 808 may include or provide connectivity to output components such as a display screen and/or an audio speaker, among other possibilities.

It should be understood that the example client device 800 is one example of a client device that may be used with the examples described herein. Numerous other arrangements are possible and contemplated herein. For instance, in other examples, the example client device 800 may include additional components not pictured and/or more or fewer of the pictured components.

### Conclusion

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
at least one processor;
at least one non-transitory computer-readable medium; and
program instructions stored on the at least one non-transitory computer-readable medium that, when executed by the at least one processor, cause the computing platform to:
receive a request to generate a given project-related correspondence entry for a given user associated with a given party involved in a construction project;
after receiving the request, make a determination of whether to generate a draft of the given project-related correspondence entry using either (i) an industry-level artificial intelligence (AI) model, or (ii) a party-level AI model for the given party; and
based on the determination, either (i) execute the industry-level AI model to generate the draft of the given project-related correspondence entry in accordance with terminology used within a construction industry or (ii) execute the party-level AI model to generate the draft of the given project-related correspondence entry in accordance with terminology that is specific to the given party.

2. The computing platform of claim 1, wherein the determination is to use the industry-level AI model to generate the draft of the given project-related correspondence entry, the computing platform further comprising program instructions stored on the at least one non-transitory computer-readable medium that, when executed by the at least one processor, cause the computing platform to:
cause the draft of the given project-related correspondence entry generated by the industry-level AI model to be presented to the given user.

3. The computing platform of claim 2, further comprising program instructions stored on the at least one non-transitory computer-readable medium that, when executed by the at least one processor, cause the computing platform to:
receive data defining interactions of the given user with the draft of the given project-related correspondence entry generated by the industry-level AI model; and
based on the received data, refine the industry-level AI model.

4. The computing platform of claim 2, further comprising program instructions stored on the at least one non-transitory computer-readable medium that, when executed by the at least one processor, cause the computing platform to:
before executing the industry-level AI model, transform the received request into a prompt for the industry-level AI model that comprises an instruction to generate the draft of the given project-related correspondence entry; and
provide the generated prompt as input to the industry-level AI model.

5. The computing platform of claim 1, wherein the determination is to use the party-level AI model to generate the draft of the given project-related correspondence entry, the computing platform further comprising program instructions stored on the at least one non-transitory computer-readable medium that, when executed by the at least one processor, cause the computing platform to:
after executing the party-level AI model to generate the draft of the given project-related correspondence entry, make a second determination of whether to (i) update the draft of the given project-related correspondence entry generated by the party-level AI model using a user-level AI model for the given user or (ii) cause the draft of the given project-related correspondence entry generated by the party-level AI model to be presented to the given user; and
based on the second determination, either (i) execute the user-level AI model to generate an updated draft of the given project-related correspondence entry in accordance with terminology that is specific to the given user, or (ii) cause the draft of the given project-related correspondence entry generated by the party-level AI model to be presented to the given user.

6. The computing platform of claim 5, further comprising program instructions stored on the at least one non-transitory computer-readable medium that, when executed by the at least one processor, cause the computing platform to:
before executing the party-level AI model, transform the received request into a prompt for the party-level AI model that comprises an instruction to generate the draft of the given project-related correspondence entry; and
provide the generated prompt as input to the party-level AI model.

7. The computing platform of claim 5, wherein the second determination is to cause the draft of the given project-related correspondence entry generated by the party-level AI model to be presented to the given user, the computing platform further comprising program instructions stored on the at least one non-transitory computer-readable medium that, when executed by the at least one processor, cause the computing platform to:
receive data defining interactions of the given user with the draft of the given project-related correspondence entry generated by the party-level AI model; and
based on the received data, refine the party-level AI model.

8. The computing platform of claim 5, wherein the second determination is to update the draft of the given project-related correspondence entry generated by the party-level AI model using the user-level AI model, the computing platform further comprising program instructions stored on the at least one non-transitory computer-readable medium that, when executed by the at least one processor, cause the computing platform to:
before executing the user-level AI model, generate a prompt for the user-level AI model that comprises an instruction to generate the updated draft of the given project-related correspondence entry; and
provide the generated prompt as input to the user-level AI model.

9. The computing platform of claim 5, further comprising program instructions stored on the at least one non-transitory computer-readable medium that, when executed by the at least one processor, cause the computing platform to:
create the user-level AI model by further training either the party-level AI model or the industry-level AI model via few-shot learning using prior project-related correspondence entries drafted by the given user.

10. The computing platform of claim 1, further comprising program instructions stored on the at least one non-transitory computer-readable medium that, when executed by the at least one processor, cause the computing platform to:
create the industry-level AI model by fine tuning a pre-trained generative AI model using prior project-related correspondence entries drafted by individuals involved in the construction industry.

11. The computing platform of claim 1, further comprising program instructions stored on the at least one non-transitory computer-readable medium that, when executed by the at least one processor, cause the computing platform to:
create the party-level AI model by fine tuning the industry-level AI model using prior project-related correspondence entries drafted by individuals associated with the given party.

12. A non-transitory computer-readable medium, wherein the non-transitory computer-readable medium is provisioned with program instructions that, when executed by at least one processor, cause a computing platform to:
receive a request to generate a given project-related correspondence entry for a given user associated with a given party involved in a construction project;
after receiving the request, make a determination of whether to generate a draft of the given project-related correspondence entry using either (i) an industry-level artificial intelligence (AI) model, or (ii) a party-level AI model for the given party; and
based on the determination, either (i) execute the industry-level AI model to generate the draft of the given project-related correspondence entry in accordance with terminology used within a construction industry or (ii) execute the party-level AI model to generate the draft of the given project-related correspondence entry in accordance with terminology that is specific to the given party.

13. The non-transitory computer-readable medium of claim 12, wherein the determination is to use the industry-level AI model to generate the draft of the given project-related correspondence entry, and wherein the non-transitory computer-readable medium is further provisioned with program instructions that, when executed by the at least one processor, cause the computing platform to:
cause the draft of the given project-related correspondence entry generated by the industry-level AI model to be presented to the given user.

14. The non-transitory computer-readable medium of claim 13, wherein the non-transitory computer-readable medium is further provisioned with program instructions that, when executed by the at least one processor, cause the computing platform to:
receive data defining interactions of the given user with the draft of the given project-related correspondence entry generated by the industry-level AI model; and
based on the received data, refine the industry-level AI model.

15. The non-transitory computer-readable medium of claim 13, wherein the non-transitory computer-readable medium is further provisioned with program instructions that, when executed by the at least one processor, cause the computing platform to:
before executing the industry-level AI model, transform the received request into a prompt for the industry-level AI model that comprises an instruction to generate the draft of the given project-related correspondence entry; and
provide the generated prompt as input to the industry-level AI model.

16. The non-transitory computer-readable medium of claim 12, wherein the determination is to use the party-level AI model to generate the draft of the given project-related correspondence entry, and wherein the non-transitory computer-readable medium is further provisioned with program instructions that, when executed by the at least one processor, cause the computing platform to:
after executing the party-level AI model to generate the draft of the given project-related correspondence entry, make a second determination of whether to (i) update the draft of the given project-related correspondence entry generated by the party-level AI model using a user-level AI model for the given user or (ii) cause the draft of the given project-related correspondence entry generated by the party-level AI model to be presented to the given user; and
based on the second determination, either (i) execute the user-level AI model to generate an updated draft of the given project-related correspondence entry in accordance with terminology that is specific to the given user, or (ii) cause the draft of the given project-related correspondence entry generated by the party-level AI model to be presented to the given user.

17. The non-transitory computer-readable medium of claim 16, wherein the second determination is to cause the draft of the given project-related correspondence entry generated by the party-level AI model to be presented to the given user, and wherein the non-transitory computer-readable medium is further provisioned with program instructions that, when executed by the at least one processor, cause the computing platform to:
receive data defining interactions of the given user with the draft of the given project-related correspondence entry generated by the party-level AI model; and
based on the received data, refine the party-level AI model.

18. The non-transitory computer-readable medium of claim 16, wherein the second determination is to update the draft of the given project-related correspondence entry generated by the party-level AI model using the user-level AI model, and wherein the non-transitory computer-readable medium is further provisioned with program instructions that, when executed by the at least one processor, cause the computing platform to:
before executing the user-level AI model, generate a prompt for the user-level AI model that comprises an instruction to generate the updated draft of the given project-related correspondence entry; and
provide the generated prompt as input to the user-level AI model.

19. The non-transitory computer-readable medium of claim 16, wherein the non-transitory computer-readable medium is further provisioned with program instructions that, when executed by the at least one processor, cause the computing platform to:
create the user-level AI model by further training either the industry-level AI model or the party-level AI model via few-shot learning using prior project-related correspondence entries drafted by the given user.

20. A method carried out by a computing platform, the method comprising:
receiving a request to generate a given project-related correspondence entry for a given user associated with a given party involved in a construction project;
after receiving the request, making a determination of whether to generate a draft of the given project-related correspondence entry using either (i) an industry-level artificial intelligence (AI) model, or (ii) a party-level AI model for the given party; and
based on the determination, either (i) executing the industry-level AI model to generate the draft of the given project-related correspondence entry in accordance with terminology used within a construction industry or (ii) executing the party-level AI model to generate the draft of the given project-related correspondence entry in accordance with terminology that is specific to the given party.
